(19) United States
(12) Patent Application Publication
(10) Pub. No.: US 2025/0242801 A1
(43) Pub. Date: Jul. 31, 2025

(54) TRAVEL CONTROL DEVICE AND METHOD FOR VEHICLE

(71) Applicant: TOYOTA JIDOSHA KABUSHIKI KAISHA, Toyota-shi (JP)

(72) Inventor: Yumi SHIMANAKA, Kasugai-shi (JP)

(73) Assignee: TOYOTA JIDOSHA KABUSHIKI KAISHA, Toyota-shi (JP)

(21) Appl. No.: 18/920,997

(22) Filed: Oct. 21, 2024

(30) Foreign Application Priority Data
Jan. 29, 2024 (JP) 2024-010997

(51) Int. Cl. B60W 30/09; B60W 30/095

(52) U.S. Cl. CPC B60W 30/09; B60W 30/0956; B60W 2554/20; B60W 2554/802

(57) ABSTRACT

The travel control device for a vehicle includes a drive assist ECU configured to execute an override control for suppressing execution of a risk reduction control on the basis of a driving operation of a driver of the vehicle when it is determined that there is a possibility that the vehicle collides with a control target object existing in front of a traveling direction of the vehicle, and execute an override control for suppressing execution of the risk reduction control on the basis of the driving operation of the driver of the vehicle. The drive assist ECU performs at least one of facilitating execution of the risk reduction control and making execution of the override control difficult when it is determined that a slow start in which the vehicle is started by being induced by the start of another vehicle existing in an adjoining lane is performed.

### CROSS-REFERENCE TO RELATED APPLICATION

This application claims priority to Japanese Patent Application No. 2024-010997 filed on Jan. 29, 2024, incorporated herein by reference in its entirety.

### BACKGROUND

### 1. Technical Field

The present disclosure relates to a travel control device and method for a vehicle such as an automobile, and more particularly, to a travel control device and method to reduce a risk that a vehicle collides against a control object.

### 2. Description of Related Art

As one of travel control devices, there is known a travel control device that reduces the risk of a collision through risk reduction control by automatic braking of the host vehicle or alarming when there is a risk that the host vehicle collides against a control object, and that performs override control to suppress execution of the risk reduction control when the driver performs a driving operation such as acceleration.

Japanese Unexamined Patent Application Publication No. 2021-37804 (JP 2021-37804 A) describes a travel control device that switches whether to perform override control to suppress execution of risk reduction control, according to whether the control target is another vehicle or the like, or whether the control target is a pedestrian or a bicycle.

### SUMMARY

In a situation where the risk reduction control is performed, it is not easy to determine whether the driving operation such as acceleration is a driving operation based on the driver's intention, an erroneous operation, or a careless driving operation. For example, in a situation where the preceding vehicle and the host vehicle are stopped, the host vehicle may start carelessly, induced by a start of a vehicle in an adjacent lane. If it is determined that the driving operation to start is a driving operation based on the driver's intention in such a situation, it is not possible to reduce the risk that the host vehicle collides against the preceding vehicle, since the risk reduction control is not performed.

The present disclosure provides an improved travel control device and method capable of reducing the risk of a collision of the host vehicle against a preceding vehicle, even in a situation where the preceding vehicle and the host vehicle are stopped and the host vehicle starts carelessly, induced by a start of a vehicle in an adjacent lane.

An aspect of the present disclosure provides a travel control device (100) for a vehicle, including a control unit (drive assist electronic control unit (ECU) 10) configured to execute, when it is determined (S50) that there is a risk that a host vehicle (102) collides against a control object that is present ahead of the host vehicle in an advancing direction, risk reduction control (S100, S130) to reduce such a risk and execute override control (S40, S60 to S80, S120) to suppress execution of the risk reduction control based on a driving operation by a driver of the host vehicle.

The control unit (drive assist ECU 10) is configured to perform (S60, S80) at least one of making the risk reduction control more likely to be executed and making the override control less likely to be executed when it is determined (S40) that a careless start in which the host vehicle is started by being induced by a start of another vehicle that is present in an adjacent lane has been performed in spite of presence of a preceding vehicle in a stationary state ahead of the host vehicle in a host vehicle's lane.

An aspect of the present disclosure also provides a travel control method for a vehicle, including: executing (S100, S130), when it is determined (S50) that there is a risk that a host vehicle (102) collides against a control object that is present ahead of the host vehicle in an advancing direction, risk reduction control to reduce such a risk; and executing (S40, S60 to S80, S120) override control to suppress execution of the risk reduction control based on a driving operation by a driver of the host vehicle.

The travel control method further includes: determining (S40) whether a careless start in which the host vehicle is started by being induced by a start of another vehicle that is present in an adjacent lane has been performed in spite of presence of a preceding vehicle in a stationary state ahead of the host vehicle in a host vehicle's lane; and performing (S60, S80) at least one of making the risk reduction control more likely to be executed and making the override control less likely to be executed when it is determined that the careless start has been performed.

According to the above travel control device and method, at least one of making the risk reduction control more likely to be executed and making the override control less likely to be executed is performed when it is determined that the careless start has been performed. Therefore, it is possible to make the risk reduction control more likely to be executed and/or make the override control less likely to be executed when a careless start in which the host vehicle is started by being induced by a start of another vehicle that is present in an adjacent lane has been performed in spite of the presence of a preceding vehicle in a stationary state ahead of the host vehicle in a host vehicle's lane. Thus, it is possible to reduce the risk that the host vehicle collides against the preceding vehicle, even in a situation where the host vehicle and the preceding vehicle are stopped and the host vehicle starts carelessly, induced by a start of a vehicle in an adjacent lane.

In one aspect of the present disclosure, the control unit (drive assist ECU 10) may be configured to make the risk reduction control more likely to be executed (S60, S80) when it is determined (S40) that the careless start has been performed, by relaxing a condition to execute the risk reduction control as compared with when it is not determined that the careless start has been performed.

According to the above aspect, the condition to execute the risk reduction control is relaxed when it is determined that the careless start has been performed as compared with when it is not determined that the careless start has been performed, and thus it is possible to make the risk reduction control more likely to be executed than when the condition to execute the risk reduction control is not relaxed.

In another aspect of the present disclosure, the control unit (drive assist ECU 10) may be configured to make the override control less likely to be executed (S60, S80) when it is determined (S40) that the careless start has been performed, by tightening a condition to execute the override control as compared with when it is not determined that the careless start has been performed.

According to the above aspect, the condition to execute the override control is tightened when it is determined that the careless start has been performed as compared with when it is not determined that the careless start has been performed, and thus it is possible to make the override control less likely to be executed than when the condition to execute the override control is not tightened.

In still another aspect of the present disclosure, the control unit (drive assist ECU 10) is configured to determine (S40, S45), in a situation where a first condition (S41) that a stopped preceding vehicle is present ahead within a range of a first distance from the host vehicle in the host vehicle's lane, a second condition (S42) that another vehicle that has been stopped ahead within a range of a second distance from the host vehicle in an adjacent lane has started, and a third condition (S44) that there is no possibility that the host vehicle makes a lane change out of the host vehicle's lane are met, that the careless start has been performed when the host vehicle starts within a reference time (S43) since the second condition is met.

According to the above aspect, it is determined, in a situation where the first to third conditions are met, that a careless start has been performed when the host vehicle starts within the reference time since the second condition is met. The first condition is that a stopped preceding vehicle is present ahead within the range of a first distance from the host vehicle in the host vehicle's lane. The second condition is that another vehicle that has been stopped ahead within the range of a second distance from the host vehicle in an adjacent lane has started. The third condition is that there is no possibility that the host vehicle makes a lane change out of the host vehicle's lane.

Therefore, it is possible to appropriately determine whether a careless start has been performed, as compared with a case where any of the first to third conditions is not required or a case where it is not required that the host vehicle should start within the reference time since the second condition is met.

In the above description, in order to help understanding of the present disclosure, the names and/or the reference signs used in the embodiment are added in parentheses to the configurations of the disclosure corresponding to the embodiment to be described later. However, each component of the present disclosure is not limited to the component of the embodiment corresponding to the name and/or the reference sign attached in parentheses. Other objects, other features, and accompanying advantages of the present disclosure will be readily understood from the description of embodiments of the present disclosure made with reference to the following drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing an embodiment of a vehicle travel control device according to the present disclosure;

FIG. 2 is a flowchart corresponding to the travel control program in the embodiment;

FIG. 3 is a flow chart illustrating a careless start determination control routine executed in S40 of FIG. 2;

FIG. 4 is a diagram illustrating a situation in which a host vehicle, a preceding vehicle, and an adjacent vehicle are stopped in front of a crosswalk;

FIG. 5 is a diagram illustrating an exemplary change in the vehicle speed of the host vehicle, the preceding vehicle, and the neighboring vehicle in the situation illustrated in FIG. 4;

FIG. 6A is a diagram illustrating a state in which a host vehicle, a preceding vehicle, and a neighboring vehicle that have been stopped start at substantially the same time; and

FIG. 6B shows the situation where the preceding vehicle maintains a stationary state, the stopping adjacent vehicle starts, and the voluntary vehicle starts while changing lane to the side of the adjacent vehicle.

### DETAILED DESCRIPTION OF EMBODIMENTS

Hereinafter, a travel control device according to an embodiment of the present disclosure will be described in detail with reference to the accompanying drawings.

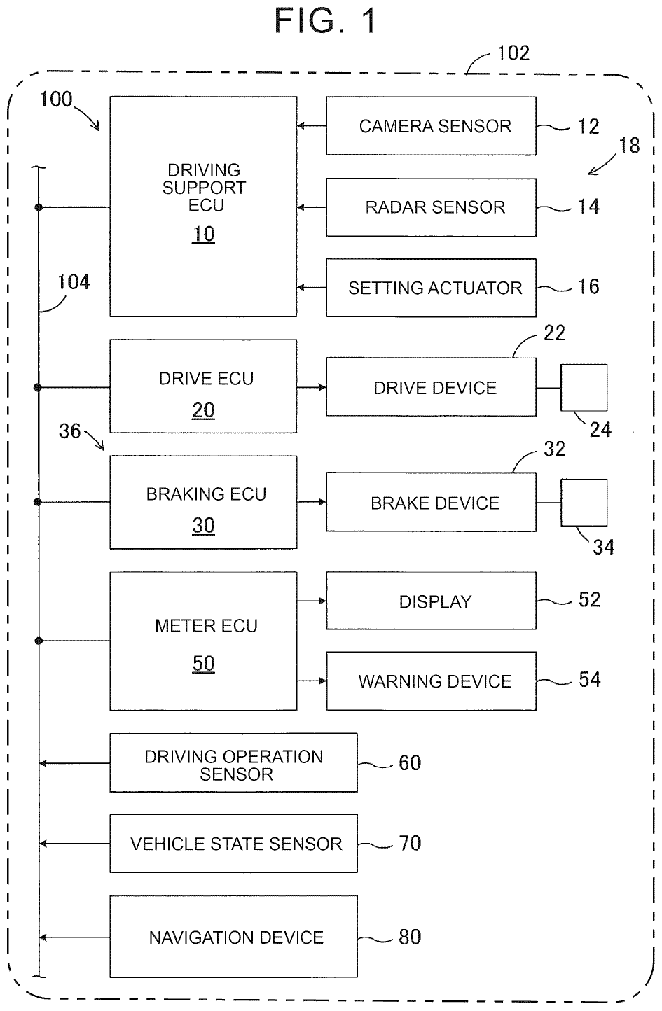

As shown in FIG. 1, a travel control device 100 according to an embodiment of the present disclosure is applied to a vehicle 102 and includes a drive assist ECU 10. The vehicle 102 is a vehicle capable of autonomous driving, and includes a drive ECU 20, a brake ECU 30, and a meter ECU 50. ECU means an Electronic Control Unit (ECU) including a microcomputer as a main part. The vehicle 102 is referred to as a host vehicle 102 as necessary in order to distinguish it from other vehicles.

A microcomputer of each ECU includes a central processing unit (CPU), a read-only memory (ROM), a random access memory (RAM), a readable and writable non-volatile memory (N/M), an interface (I/F), and the like. The CPU realizes various functions by executing instructions (programs, routines) stored in the ROM. Furthermore, these ECU are connected to each other in a data-exchangeable manner via a Controller Area Network (CAN) 104. Therefore, detected values of sensors (including switches) connected to a specific ECU are transmitted to other ECUs as well.

The drive assist ECU 10 is a central control device that performs driving assistance travel control such as travel control, tracking inter-vehicle distance control, and lane keeping control. In an embodiment, the drive assist ECU 10 cooperates with other ECU to perform travel control for the vehicle 102, as will be described further below. In the embodiment, when it is determined that there is a possibility that the subject vehicle collides with the control target object existing in front of the traveling direction of the subject vehicle, the drive assist ECU 10 executes a risk reduction control for reducing the risk. Further, the drive assist ECU 10 executes the override control for suppressing the execution of the risk reduction control on the basis of the driving manipulation of the driver of the host vehicle.

A camera sensor 12, a radar sensor 14, and a setting operation device 16 are connected to the drive assist ECU 10. The camera sensor 12 and radar sensor 14 each include a plurality of camera devices and a plurality of radar devices. The camera sensor 12 and the radar sensor 14 function as a target information acquisition device 18 that acquires target information around the vehicle 102.

Each camera device of the camera sensor 12 includes a camera unit that captures an image of the surroundings of the vehicle 102, and a recognition unit that analyzes image data obtained by capturing an image by the camera unit and recognizes a target such as a white line of a road or another vehicle, although not shown in the drawing. The recognition unit supplies information about the recognized target to the drive assist ECU 10 at predetermined intervals.

Each radar device of the radar sensor 14 includes a radar transceiver and a signal processor (not shown). The radar transmitting/receiving unit emits a radio wave (hereinafter, referred to as “millimeter wave”) in a millimeter wave band, and receives a millimeter wave (that is, a reflected wave) reflected by a three-dimensional object (for example, another vehicle, a bicycle, or the like) existing in a radiation range. The signal processor supplies information indicating a distance between the host vehicle and the three-dimensional object, a relative speed between the host vehicle and the three-dimensional object, a relative position (direction) of the three-dimensional object with respect to the host vehicle, and the like to the drive assist ECU 10 at predetermined time intervals on the basis of a phase difference between the transmitted millimeter wave and the received reflected wave, an attenuation level of the reflected wave, a time period from the transmission of the millimeter wave to the reception of the reflected wave, and the like. Incidentally, in lieu of the radar sensor 14, or in addition to the radar sensor 14, Light Detection And Ranging (LiDAR) may be used.

The setting operation device 16 is provided at a position that can be operated by a driver, such as a steering wheel (not shown in FIG. 1), and is operated by the driver. Although not shown in FIG. 1, the setting operation device 16 includes a driving assistance switch. The drive assist ECU 10 executes the driving control when the driving assistance switch is on, as will be described later.

A drive device 22 that accelerates the vehicle 102 by applying a driving force to the driving wheels 24 is connected to the drive ECU 20. The drive ECU 20 normally controls the drive device 22 such that a driving force generated by the drive device 22 changes in accordance with a driving operation by the driver, and controls the drive device 22 based on a command signal when the drive ECU 20 receives the command signal from the drive assist ECU 10.

A brake device 32 is connected to the brake ECU 30 to decelerate the vehicle 102 by braking by applying a braking force to the wheels 34. The brake ECU 30 executes automatic braking in which the brake ECU 30 normally controls the brake device 32 such that a braking force generated by the brake device 32 changes in accordance with a braking operation by the driver, and controls the brake device 32 based on a command signal when the brake ECU 30 receives the command signal from the drive assist ECU 10.

Thus, the brake ECU 30 and the brake device 32 cooperate with each other to function as an automated brake device 36. When braking force is applied to the wheels by driving control or the like, a brake lamp (not shown in FIG. 1) is turned on.

The meter ECU 50 is connected with a touch panel-type display 52 for displaying a state of control by the drive assist ECU 10 and an alarm device 54 for issuing an alarm. The display 52 may be, for example, a multi-information display in which meters and various types of information are displayed, or may be a display of the navigation device 80 described later. As will be described later, the display 52, upon receiving a signal from the drive assist ECU 10, displays the status of the travel control.

The alarm device 54 is activated when it is determined that there is a possibility that the vehicle 102 collides with a control object such as an obstacle, and starts an alarm as one of the risk reduction controls for reducing the risk of collision, that is, starts an alarm indicating that the vehicle 102 may collide with the control object. The alarm device 54 may be any of an alarm device that issues a visual alarm such as an alarm lamp, an alarm device that emits an auditory alarm such as an alarm buzzer, and an alarm device that issues a bodily alarm such as vibration of a seat, and may be any combination thereof.

The driving operation sensor 60 and the vehicle state sensor 70 are also connected to CAN 104. Information detected by the driving operation sensor 60 and the vehicle state sensor 70 (hereinafter referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 60 includes a drive operation amount sensor that detects an operation amount of an accelerator pedal, a braking operation amount sensor that detects a master cylinder pressure or a depression force applied to a brake pedal, and a brake switch that detects whether the brake pedal is operated. The driving operation sensor 60 includes a steering angle sensor for detecting a steering angle, a steering torque sensor for detecting a steering torque, and the like.

The vehicle state sensor 70 includes a vehicle speed sensor that detects the vehicle speed V of the vehicle 102, a longitudinal acceleration sensor that detects longitudinal acceleration of the vehicle, a lateral acceleration sensor that detects lateral acceleration of the vehicle, a yaw rate sensor that detects a yaw rate of the vehicle.

In addition, a navigation device 80 is also connected to CAN 104. The navigation device 80 includes a global positioning system (GPS) receiver that detects the position of the vehicle 102, a storage device that stores map information and road information, and a communication device that acquires the latest information of the map information and the road information from the outside. In particular, the road information may include information on a position at which the vehicle may temporarily stop, such as an intersection or a crosswalk. Note that the navigation device 80 may not be provided.

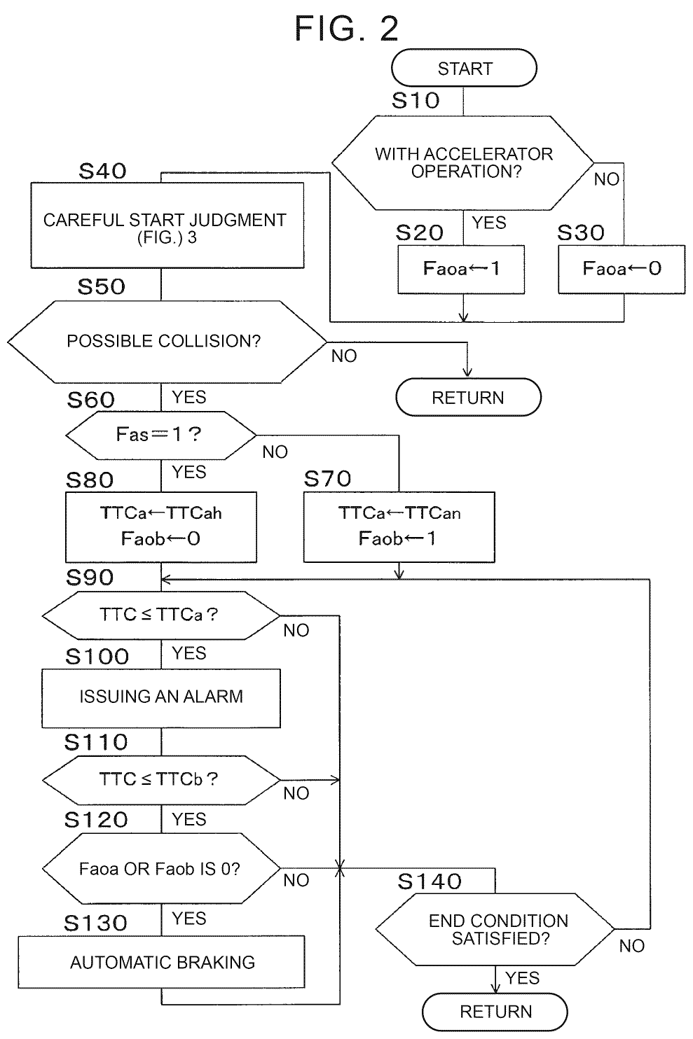

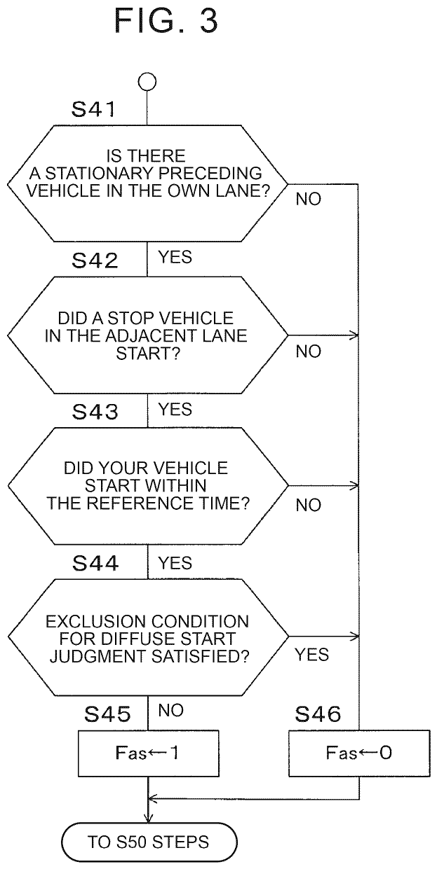

In the embodiment, ROM of the drive assist ECU 10 stores a travel control program corresponding to the flow charts illustrated in FIGS. 2 and 3.

### Travel Control (FIG. 2)

Next, the travel control according to the embodiment will be described with reference to the flowchart shown in FIG. 2. The traveling control according to the flow chart shown in FIG. 2 is repeatedly executed at predetermined intervals by CPU of the drive assist ECU 10 in a situation where the driving assistance switch is on. When the travel control starts, the flags Faoa, Faob and Fas are initialized to 0.

First, in S10, CPU determines whether or not an accelerator operation has been performed by the driver based on the operation amount of the accelerator pedal detected by the drive operation amount sensor of the driving operation sensor 60. When an affirmative determination is made, the flag Faoa is set to 1 in S20, and when a negative determination is made, the flag Faoa is set to 0 in S30. Faoa of 1 indicates that the driver has determined that the accelerator operation has been performed, and Faoa of 0 indicates that the driver has not determined that the accelerator operation has been performed. When the accelerator operation amount is equal to or greater than the reference opening degree or when the accelerator operation amount speed is equal to or greater than the reference opening degree speed, it may be determined that the accelerator operation has been performed by the driver.

In S40, CPU performs a careless start determination according to the routine shown in FIG. 3 described later. As will be described later, when it is determined that the host vehicle 102 has started slowly, the flag Fas is set to 1, and when it is determined that the host vehicle 102 has not started slowly, the flag Fas is reset to 0.

In S50, CPU determines whether or not the host vehicle is likely to collide with the preceding vehicle based on, for example, a distance between the host vehicle and the preceding vehicle detected by the camera sensor 12 or the radar sensor 14 and a relative speed of the host vehicle with respect to the preceding vehicle. If it is determined that there is no possibility of collision, the present control ends, and if it is determined that there is a possibility of collision, the present control proceeds to S60.

In S60, CPU determines whether or not the flag Fas is 1, that is, whether or not it is determined that the host vehicle 102 has started carelessly in S40. When an affirmative determination is made, the present control proceeds to S80, and when a negative determination is made, the present control proceeds to S70.

In S70, CPU sets the warning reference value TTCa of the predicted collision-time TTC for determining whether or not to issue the warning to the standard value TTCan (positive constant), and sets the flag Faob to 1. The flag Faob being 1 means that accelerator override is enabled.

In S80, CPU sets the warning reference value TTCa of the predicted collision-time TTC to a value TTCah (positive constant) larger than the standard value TTCan, and resets the flag Faob to 0. When the flag Faob is 0, it means that the accelerator override is disabled.

In S90, CPU calculates a predicted collision-time TTC which is a predicted time until the vehicle 102 collides with the preceding vehicle. The predicted collision-time TTC is calculated based on the distance Dr between the host vehicle and the preceding vehicle based on the detection result by the target information acquisition device 18 and the relative-speed Vr of the host vehicle with respect to the preceding vehicle, for example, according to Equation (1) below. The predicted collision-time TTC is an index indicating a height of a possibility that the host vehicle collides with the preceding vehicle, and the smaller the value, the higher the possibility (risk) that the host vehicle collides with the preceding vehicle.

TTC=Dr/Vr (1)

Further, CPU determines whether or not the predicted collision-time TTC

is equal to or less than the warning reference value TTCa, that is, determines whether or not an alarm indicating that the host vehicle is likely to collide with the preceding vehicle needs to be issued. When a negative determination is made, the present control determination proceeds to S140, and when an affirmative determination is made, the present control proceeds to S100.

In S100, CPU outputs a command signal to the meter ECU 50 to display an alarm indicating that the host vehicle is likely to collide with the preceding vehicle on the display 52, and activates the alarm device 54 to issue an alarm indicating that the host vehicle is likely to collide with the preceding vehicle.

In S110, CPU determines whether or not the predicted collision-time TTC is equal to or less than the automated brake reference value TTCb, that is, determines whether or not automatic braking by the automated brake device 36 needs to be performed in order to reduce the possibility of collision. When a negative determination is made, the present control determination proceeds to S140, and when an affirmative determination is made, the present control proceeds to S120.

In S120, CPU determines whether the flag Faoa or the flag Faob is 0. When a negative determination is made, the present control determination proceeds to S140, and when an affirmative determination is made, the present control proceeds to S130.

In S130, CPU outputs a command signal to the brake ECU 30 to brake the subject vehicle by the automatic braking by the automated brake device 36 in order to reduce the risk of a crash.

In S140, CPU determines whether the termination condition of the present control is satisfied. When a negative determination is made, the present control determination returns to S90, and when an affirmative determination is made, the present control ends once.

When any of E1 to E3 below is satisfied, it may be determined that the termination condition of the present control is satisfied.
E1: There is no possibility of the host vehicle colliding with the preceding vehicle.
E2: The preceding car started.
E3: Host vehicle changed lane.

As can be seen from the above description, in the embodiment, the reduction control for reducing the possibility that the host vehicle collides with the preceding vehicle is the start of an alarm by the operation of the alarm device 54 and the automatic braking by the automated brake device 36.

### Careful Start Determination Control (FIG. 3)

Next, referring to the flow chart shown in FIG. 3, a careless start determination control executed in the above-described S40 will be described.

In S41, CPU determines whether there is a stationary preceding vehicle in the own lane (whether the first condition is satisfied). When a negative determination is made, the present control proceeds to step 46, and when an affirmative determination is made, the present control proceeds to S42.

When all of A1 to A3 described below are satisfied, it may be determined that there is a stationary preceding vehicle in the own lane.
A1: The preceding vehicles are within the scope of the own lane.
A2: The preceding vehicle is within a reference range (positive constant) from the host vehicle.
A3: The preceding vehicles are stopped.

In S42, CPU determines whether the vehicles stopped in the neighboring lane have started (whether the second condition is satisfied). When a negative determination is made, the present control proceeds to step 46, and when an affirmative determination is made, the present control proceeds to S43.

When all of B1 to B4 described below are satisfied, it may be determined that the vehicles stopped in the neighboring lanes have started.
B1: In the previous cycle, the neighboring vehicles were within the neighboring lanes.
B2: In the previous cycle, the neighboring vehicle was within the reference range from the host vehicle. The reference range may be a range of a predetermined distance (positive constant) from the side of the host vehicle to the front of the host vehicle.
B3: In the previous cycle, neighboring vehicles were stopped.
B4: In the current cycling, neighboring vehicles are moving forward.

In S43, CPU determines whether the vehicle has started within the reference period after the second condition is satisfied. When a negative determination is made, the present control proceeds to step 46, and when an affirmative determination is made, the present control proceeds to S44. In the previous cycle, the host vehicle is stopped, but in the current cycle, when the host vehicle is moving forward, it may be determined that the host vehicle has started.

In S44, CPU determines whether an exclusion criterion for the diffuse start determination is satisfied. When a negative determination is made, it is determined in S45 that the start of the host vehicle is a slow start, and the flag Fas is set to 1. On the other hand, when the affirmative determination is made, it is determined in S46 that the start of the host vehicle is not a slow start, and the flag Fas is reset to 0.

When all of C1 to C3 described below are satisfied, it may be determined that the exclusion condition of the diffuse start determination is satisfied. In particular, the fact that C1 and C2 described below are not satisfied is a third condition that there is no possibility that the host vehicle 102 changes the lane outside the host lane.
C1: The winker is being operated towards the neighboring vehicles.
C2: The steering angle θ is equal to or greater than the reference steering angle (positive constant) toward the neighboring vehicle.
C3: The elapsed time since the neighboring vehicles started traveling is equal to or greater than the reference elapsed time (positive constant).

### Operation and Effect of Embodiment

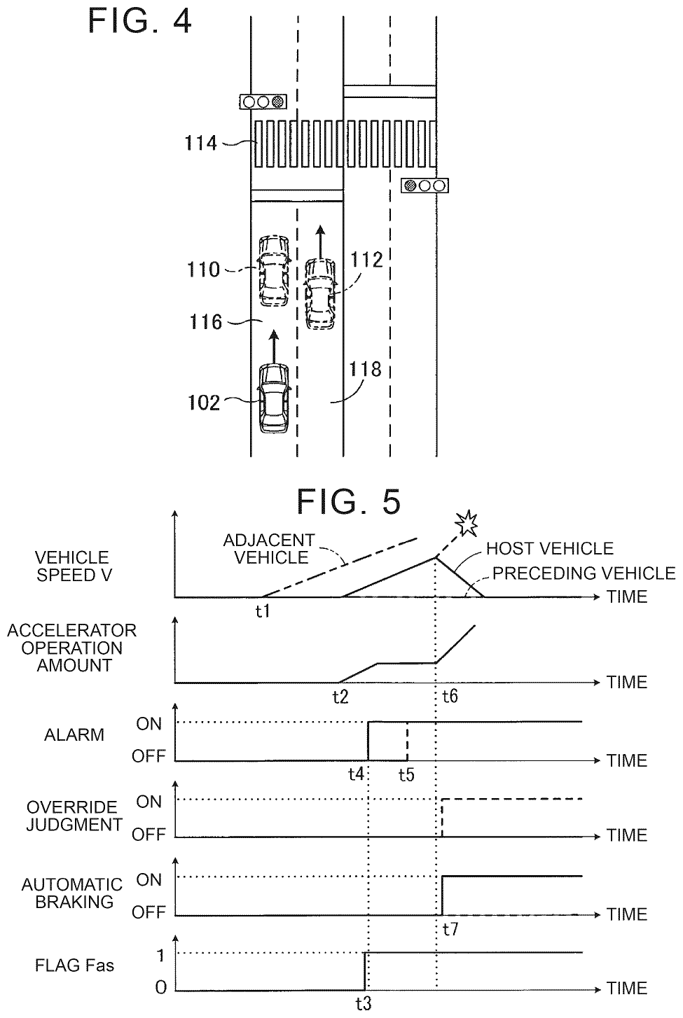

### When Subject Vehicle Starts Carelessly (FIG. 4, FIG. 5)

For example, FIG. 4 illustrates a situation in which the host vehicle 102, the preceding vehicle 110, and the adjacent vehicle 112 are stopped in front of the crosswalk 114. The preceding vehicle 110 is in front of the host vehicle 102 in the own lane 116, and the adjacent vehicle 112 is located in the adjacent lane 118 obliquely in front of the host vehicle 102. While the preceding vehicle 110 remains stationary, as indicated by the arrows, the stopping adjacent vehicle 112 starts, and accordingly the host vehicle 102 also starts.

In the situation illustrated in FIG. 4, an affirmative determination is made in S41 to S43, a negative determination is made in S44, and a flag Fas is set to 1 in S45. In addition, an affirmative determination is made in S10, S50 and S60. Therefore, in S80, the warning reference value TTCa of the predicted collision-time TTC is set to a value TTCah larger than the standard value TTCan, and the flag Faob is reset to 0.

Therefore, since an affirmative determination is easily performed in S90, the issuance of an alert in S100 is performed early. Further, when an affirmative determination is made in S110, since an affirmative determination is made in S120, the automatic braking of S130 is executed without being prohibited, and the host vehicle 102 is automatically braked, thereby preventing collision with the preceding vehicle 110.

FIG. 5 illustrates an example of a change in the vehicle speed of the host vehicle 102, the preceding vehicle 110, and the adjacent vehicle 112 in the situation illustrated in FIG. 4.

In FIG. 5, it is assumed that the adjacent vehicle 112 starts at the time point t1, the accelerator pedal is depressed by the driver of the host vehicle 102 at the time point t2, and an increase in the accelerator operation amount is started, and the host vehicle 102 starts immediately after that.

At the time point t3 immediately after the host vehicle 102 starts, the flag Fas is set to 1, and S80 is executed, whereby the warning reference value TTCa of the predicted collision-time TTC is set to a value TTCah larger than the standard value TTCan, and the flag Faob is reset to 0. Therefore, when the flag Fas is 0, the alarm is started at a time point t4 earlier than the time point t5 at which the alarm is started.

Further, it is assumed that, at the time point t6, the accelerator pedal is further depressed by the driver of the host vehicle 102 to increase the accelerator operation amount, and the determination of S110 becomes affirmative at the time point t7 immediately after that. Since an affirmative determination is made in S120, S130 is executed and the host vehicle 102 is automatically braked, thereby preventing collision with the preceding vehicle 110.

In the conventional travel control device, S40 and S60 to S80 are not executed, and in S120, it is determined whether or not the flag Faoa is 0, and it is not determined whether or not the flag Faob is 0.

Therefore, when the determination of S110 is affirmative, since a negative determination is made in S120 and S130 is not executed, the host vehicle 102 is not automatically braked even when the time point t7 is reached, as indicated by a broken line in FIG. 5. Therefore, it is not possible to suppress the host vehicle colliding with the preceding vehicle 110.

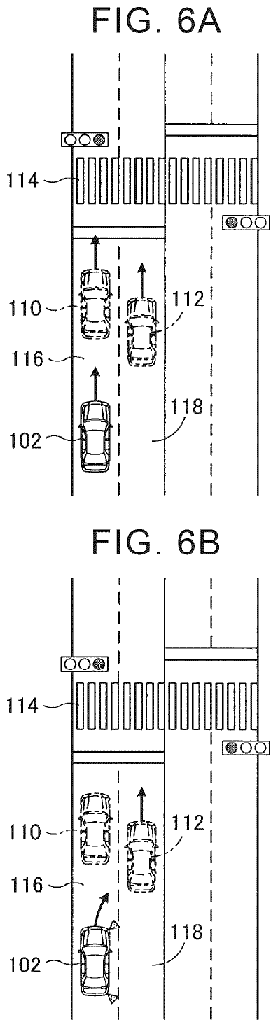

### When Preceding Car Starts (FIG. 6A)

FIG. 6A shows a situation in which the host vehicle 102, the preceding vehicle 110, and the adjacent vehicle 112, which have been stopped, start at substantially the same time, as indicated by arrows.

In the situation shown in FIG. 6A, a negative determination is made in S41 and the flag Fas is reset to 0 in S46. Therefore, even if an affirmative determination is made in S10, since a negative determination is made in S60, the reference value TTCa of the predicted collision-time TTC is set to the standard value TTCan and the flag Faob is set to 1 in S70.

Since the predicted collision-time TTC is not small, a negative determination is made in S90, and S100 and S130 of the alarm are not performed. Further, since the reference value TTCa is set to the standard value TTCan, even if an affirmative determination is made in S90, the issuance of an alarm is not started early. Further, even if an affirmative determination is made in S90, since a negative determination is made in S120, the self-vehicle is not automatically braked.

### When Subject Vehicle Changes Lane (FIG. 6B)

In FIG. 6B, the preceding vehicle 110 remains stationary, and the stopping adjacent vehicle 112 starts, as indicated by an arrow, and the host vehicle 102 starts while changing the lane toward the adjacent vehicle 112.

In the situation shown in FIG. 6B, an affirmative determination is made in S41 to S44, and the flag Fas is reset to 0 in S46. Therefore, even if an affirmative determination is made in S10, since a negative determination is made in S60, the reference value TTCa of the predicted collision-time TTC is set to the standard value TTCan and the flag Faob is set to 1 in S70.

Thus, similarly to the case in FIG. 6A, no S100 and S130 are performed. Further, even if an affirmative determination is made in S90, the issuance of an alarm is not started early. Further, even if an affirmative determination is made in S90, since a negative determination is made in S120, the self-vehicle is not automatically braked.

As can be seen from the above explanation, according to the travel control device and the travel control method of the present disclosure, when it is determined that the careless start has been performed (S40), at least one of facilitating the execution of the risk reduction control and the difficulty in the execution of the override control is performed (S60, S80). Therefore, in a case where a preceding vehicle in a stationary state exists in front of the host vehicle in the own lane, and a slow start in which the host vehicle starts due to the induction of the other vehicle existing in the adjacent lane is performed, it is possible to easily execute the risk reduction control and/or to make it difficult to execute the override control. Therefore, in a situation in which the host vehicle and the preceding vehicle are stopped, even in a situation in which the host vehicle slowly starts as the vehicle of the adjacent lane starts, it is possible to reduce the possibility that the host vehicle collides with the preceding vehicle.

In addition, according to the traveling control device and method of the present disclosure, when it is determined that the careless start has been performed (S40), the execution condition of the risk reduction control is relaxed (S60, S80) as compared with the case where it is not determined that the careless start has been performed. Therefore, it is possible to easily execute the risk reduction control as compared with the case where the execution condition of the risk reduction control is not relaxed.

Further, according to the traveling control device and method of the present disclosure, when it is determined that the diffuse starting has been performed (S40), the execution condition of the override control is made severe (S60, S80) compared to when it is not determined that the diffuse starting has been performed. Therefore, it is possible to make it difficult to execute the override control as compared with a case where the execution condition of the override control is not severe.

Further, according to the traveling control device and the traveling control device of the present disclosure, when the first to third conditions are satisfied and when the vehicle starts within the reference period after the second condition is satisfied, it is determined that the vehicle has been started carelessly (S40, S45). The first condition is that there is a stopping preceding vehicle in front of the subject vehicle within the first distance from the subject vehicle in the subject lane (S41). The second condition is that another vehicle that has stopped forward within the second distance from the host vehicle in the neighboring lane has started (S42). The third condition is that there is no possibility that the host vehicle will change the lane outside the host lane (S44). Therefore, it is possible to appropriately determine whether the vehicle has started carelessly as compared with a case where any one of the first to third conditions is not required or a case where it is not required that the vehicle has started within the reference time after the second condition is satisfied.

The present disclosure has been described in detail above with respect to specific embodiments. However, it is obvious to those skilled in the art that the present disclosure is not limited to the above-described embodiments, and various other embodiments are possible within the scope of the present disclosure.

For example, in the above-described embodiment, when it is determined that a slow start in which the host vehicle starts is performed by being triggered by the start of another vehicle existing in an adjacent lane, both the possibility reduction control is easily executed and the override control is hardly executed. That is, in S80, the warning reference value TTCa is set to a value TTCah larger than the standard value TTCan, and the flag Faob is reset to 0. However, only one of facilitating execution of the risk reduction control and preventing execution of the override control may be performed.

Further, in the above-described embodiment, the risk reduction control is a start (S100) of an alarm and an automatic braking (S130), but the risk reduction control may be one of a start of an alarm and an automatic braking, and may include, in addition to the start of the alarm and/or the automatic braking, an automatic steering for reducing a risk that the host vehicle collides with the preceding vehicle.

Further, in the above-described embodiment, when it is determined that the careless start has been performed (S40), the warning reference value TTCa is set to a value TTCah larger than the standard value TTCan, so that the execution condition of the risk reduction control is relaxed (S60, S80). However, the reduction of the execution condition of the risk reduction control may be performed by other means such as the reduction correction of the automated brake reference value TTCb.

Further, in the above-described embodiment, the override control for suppressing the execution of the risk reduction control is executed based on an accelerator operation (S10) of the driver of the host vehicle. However, the override control may be executed based on a driving operation such as a braking operation or a steering operation in addition to an accelerator operation of a driver of the host vehicle.

What is claimed is:

1. A travel control device for a vehicle, including a control unit configured to execute, when it is determined that there is a risk that a host vehicle collides against a control object that is present ahead of the host vehicle in an advancing direction, risk reduction control to reduce such a risk and execute override control to suppress execution of the risk reduction control based on a driving operation by a driver of the host vehicle, wherein the control unit is configured to perform at least one of making the risk reduction control more likely to be executed and making the override control less likely to be executed when it is determined that a careless start in which the host vehicle is started by being induced by a start of another vehicle that is present in an adjacent lane has been performed in spite of presence of a preceding vehicle in a stationary state ahead of the host vehicle in a host vehicle's lane.

2. The travel control device for a vehicle according to claim 1, wherein the control unit is configured to make the risk reduction control more likely to be executed when it is determined that the careless start has been performed, by relaxing a condition to execute the risk reduction control as compared with when it is not determined that the careless start has been performed.

3. The travel control device for a vehicle according to claim 1, wherein the control unit is configured to make the override control less likely to be executed when it is determined that the careless start has been performed, by tightening a condition to execute the override control as compared with when it is not determined that the careless start has been performed.

4. The travel control device for a vehicle according to claim 1, wherein the control unit is configured to determine, in a situation where
a first condition that a stopped preceding vehicle is present ahead within a range of a first distance from the host vehicle in the host vehicle's lane,
a second condition that another vehicle that has been stopped ahead within a range of a second distance from the host vehicle in an adjacent lane has started, and
a third condition that there is no possibility that the host vehicle makes a lane change out of the host vehicle's lane
are met, that the careless start has been performed when the host vehicle starts within a reference time since the second condition is met.

5. A travel control method for a vehicle, comprising:
executing, when it is determined that there is a risk that a host vehicle collides against a control object that is present ahead of the host vehicle in an advancing direction, risk reduction control to reduce such a risk; and
executing override control to suppress execution of the risk reduction control based on a driving operation by a driver of the host vehicle, the travel control method further comprising:
determining whether a careless start in which the host vehicle is started by being induced by a start of another vehicle that is present in an adjacent lane has been performed in spite of presence of a preceding vehicle in a stationary state ahead of the host vehicle in a host vehicle's lane; and performing at least one of making the risk reduction control more likely to be executed and making the override control less likely to be executed when it is determined that the careless start has been performed.
